(19) United States
(12) Patent Application Publication
(10) Pub. No.: US 2026/0364784 A1
(43) Pub. Date: Nov. 19, 2026

(54) HANDLING APPARATUS FOR PHARMACEUTICAL PRODUCTION MATERIAL, HANDLING SYSTEM WITH A HANDLING APPARATUS AND PLANT FOR PROCESSING PHARMACEUTICAL CONTAINERS

(71) Applicant: Bausch + Stroebel SE + Co. KG, Ilshofen (DE)

(72) Inventors: Dieter Stieben, Ilshofen (DE); Martina Graeter, Ilshofen (DE); Klaus Kaiser, Ilshofen (DE); Daniel Spieler, Ilshofen (DE); Michael Hemer, Ilshofen (DE)

(21) Appl. No.: 19/722,280

(22) Filed: Jun. 26, 2026

Related U.S. Application Data
(63) Continuation of application No. PCT/EP2024/086544, filed on Dec. 16, 2024.

(30) Foreign Application Priority Data
Dec. 29, 2023 (DE) 10 2023 136 888.5

(51) Int. Cl. B25J 9/10; B25J 9/04; B25J 15/00; B25J 21/00

(52) U.S. Cl. CPC B25J 9/102; B25J 9/043; B25J 9/1045; B25J 15/0052; B25J 21/005

(57) ABSTRACT

A handling apparatus for pharmaceutical production material includes a supporting device, a joint device and a drive device. The joint device has a jointed arm portion that is rotatable relative to the supporting device. A tool for handling production material is held on the jointed arm portion. A first drive element can be driven in rotation and connected in a rotationally fixed manner to the jointed arm portion. A second drive element, which can also be driven in rotation, can be coupled to an output element via a transmission device. The output element is operatively connected to the tool for rotating the tool relative to the jointed arm portion. The jointed arm portion has or forms a housing that accommodates the transmission device. The handling apparatus can be part of a handling system, and the handling system can be incorporated in a plant for processing containers.

### CROSS-REFERENCE TO RELATED APPLICATIONS

This application is a continuation patent application of international application number PCT/EP2024/086544, filed on Dec. 16, 2024, and claims the benefit of priority of German application number 10 2023 136 888.5, filed on Dec. 29, 2023, the contents of both applications being incorporated by reference herein in their entireties and for all purposes.

### FIELD

The present disclosure relates to a handling apparatus for pharmaceutical production material, comprising a supporting device and a joint device, which comprises a first jointed arm portion that is rotatable relative to the supporting device, and a tool for handling the production material, which is held directly or indirectly on the first jointed arm portion, and at least one drive device.

The present disclosure further relates to a handling system for pharmaceutical production material, comprising a frame that can be placed on a set-down surface and that comprises a separating element that separates a first zone from a second zone, and a handling apparatus of the type described above.

The present disclosure moreover relates to a plant for processing pharmaceutical containers.

### BACKGROUND

In such a plant, supplied containers are, for example, weighed, filled with a product, weighed again, sealed, and then discharged for further processing. Accordingly, the plant can have a plurality of processing stations—for example, at least one weighing station, one filling station, one sealing station, one inspection station, and/or one packaging station. The containers can comprise, for example, vials, syringes, cartridges, or ampules. They can be stable containers that can stand independently on a set-down element. Non-stable objects are also conceivable, which are held, for example, by means of forcipate gripping elements.

In the present case, containers as primary packaging materials are considered pharmaceutical production material, which is not limited to such containers, however. In the present case, for example, secondary packaging materials, in particular trays or tubs accommodating a plurality of containers, can also be considered pharmaceutical production material. Other production materials include, for example, closing elements for closing the containers. Such closing elements can include, for example, plugs, mushroom caps, or crimp caps. It is also conceivable for production material to include items used to process the containers in the plant. Examples include filling needles, hoses, container retaining elements, or other production material. In general, for example, format parts of the plant that have container-specific or container processing-specific properties can be counted as production material.

The handling apparatus of the type mentioned above is used for handling pharmaceutical production material, in particular within such a plant for processing the containers. In this process, the production material is held with the tool, which can have different configurations, in particular depending upon the production material. The tool can be moved by means of the joint device, which can, for example, form a jointed arm and which comprises at least a first jointed arm portion that can be moved relative to the supporting device. At least one drive device is used for propulsion. It is conceivable, in particular, that a control apparatus be provided for controlling the operation of the handling apparatus.

Machine handling apparatuses for production material are already known. For example, WO 2022/136537 A1 describes a handling apparatus in the form of an jointed arm robot (Scara) in a plant for processing containers. This handling apparatus has proven itself in practice for the tasks assigned to it. Nevertheless, it would be desirable to provide a handling apparatus that includes advantageous properties for processing the production material.

An object underlying the present disclosure is to provide a handling apparatus of the generic type that has advantageous properties for processing the production material. The object is furthermore to provide a handling system with such a handling apparatus and a plant for processing containers with such a handling system.

### SUMMARY

In a first aspect of the present disclosure, a handling apparatus for pharmaceutical production material is provided. The apparatus comprises a supporting device, a joint device, which comprises a first jointed arm portion that is rotatable relative to the supporting device, a tool for handling the production material, which is held directly or indirectly on the first jointed arm portion, and at least one drive device. The handling apparatus comprises a first drive element which can be driven in rotation about the first axis of rotation and is connected in a rotationally fixed manner to the first jointed arm portion and a second drive element which can be driven in rotation about an axis of rotation and is coupled to a first output element via a first transmission device. The first output element is operatively connected directly or indirectly to the tool, for rotating the tool about a second axis of rotation relative to the first jointed arm portion. The first jointed arm portion comprises or forms a first jointed arm portion housing in which the first transmission device is accommodated.

In a second aspect of the present disclosure a handling system for pharmaceutical production material is provided. The system comprises a frame that can be placed on a set-down surface and that comprises an, for example, plate-shaped separating element that separates a first zone from a second zone. The first zone is of a higher cleanliness class than the second zone. The handling system comprises a handling apparatus in accordance with the first aspect. The supporting device and the joint device are arranged in the first zone. The at least one drive device is arranged in the second zone, wherein at least one coupling element of the handling apparatus is passed through a through-opening of the separating element.

In a third aspect of the present disclosure a plant for processing pharmaceutical containers is provided. The plant comprises a handling system in accordance with the second aspect and further comprises or forms a closing station for the containers. At least one further processing station for the containers is provided, for example a filling station.

### BRIEF DESCRIPTION OF THE DRAWINGS

The foregoing summary and the following description may be better understood in conjunction with the drawing figures, of which:

FIG. 1: shows a plant in accordance with the present disclosure for processing pharmaceutical containers in a preferred embodiment, comprising a handling system in accordance with the present disclosure with a handling apparatus in accordance with the present disclosure, each in a preferred embodiment;

FIG. 2: shows a schematic representation of the handling system of the plant from FIG. 1;

FIG. 3: shows a perspectival partial representation of the handling apparatus and of a closing apparatus of the handling system from FIG. 1;

FIG. 4: shows a partial perspectival representation of the handling system from FIG. 1;

FIG. 5: shows a perspectival partial representation of the handling apparatus, omitting some components;

FIG. 6: shows a representation corresponding to FIG. 5 in a different perspective;

FIG. 7: shows a side view of the handling apparatus along arrow “7” in FIG. 5;

FIG. 8: shows a sectional view along line 8-8 in FIG. 7;

FIG. 9: shows a side view of the handling apparatus, wherein its tool is in a receiving position for closing elements;

FIG. 10: shows the handling apparatus from FIG. 9, wherein the tool is in a transfer position; and

FIGS. 11 and 12: show representations corresponding to FIG. 9 or 10, wherein the closing elements are used for closing containers of different sizes.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a handling apparatus for pharmaceutical production material, comprising a supporting device and a joint device, which comprises a first jointed arm portion that is rotatable relative to the supporting device, and a tool for handling the production material, which is held directly or indirectly on the first jointed arm portion, and at least one drive device. The handling apparatus comprises a first drive element which can be driven in rotation about the first axis of rotation and is connected in a rotationally fixed manner to the first jointed arm portion and a second drive element which can be driven in rotation about an axis of rotation and is coupled to a first output element via a first transmission device. The first output element is operatively connected directly or indirectly to the tool, for rotating the tool about a second axis of rotation relative to the first jointed arm portion. The first jointed arm portion comprises or forms a first jointed arm portion housing in which the first transmission device is accommodated.

With a handling apparatus of the type mentioned at the outset, the aforementioned object is achieved in accordance with the present disclosure wherein the handling apparatus comprises a first drive element which can be driven in rotation about the first axis of rotation and is connected in a rotationally fixed manner to the first jointed arm portion, and a second drive element which can be driven in rotation about an axis of rotation and is coupled to a first output element via a first transmission device, which first output element is operatively connected directly or indirectly to the tool, for rotating the tool about a second axis of rotation relative to the first jointed arm portion, and wherein the first jointed arm portion comprises or forms a first jointed arm portion housing in which the first transmission device is accommodated.

The present disclosure incorporates the consideration that the tool for the production material can be moved in different ways on the joint device, which in particular comprises or forms a jointed arm. While in the prior art document WO 2022/136537 A1 a drive motor is required at each joint of the joint device, in the handling apparatus in accordance with the present disclosure a driving force can be transmitted to the tool through the first jointed arm portion. Furthermore, the first jointed arm portion can itself be rotated about the first axis of rotation relative to the supporting device. For the purposes mentioned above, the at least one drive device comprises, for example, a first drive motor which is coupled indirectly or directly to the first drive element in order to enable the first jointed arm portion to rotate about the first axis of rotation. The drive device comprises, for example, a second drive motor that is coupled indirectly or directly to the second drive element in order to rotate it. The second drive element drives the first transmission device and, via the first transmission device, indirectly or directly drives the tool. The first transmission device is arranged in the first jointed arm portion housing, which in particular offers the possibility of encapsulating the transmission device, preferably in a pharmaceutically sealed state.

The ability to transmit a driving force to the tool through the first jointed arm portion offers the possibility of a compact design for the handling apparatus in practice. Preferably, the at least one drive device can be arranged outside the joint device and the supporting device. This allows the joint device to be made not only more compact, but also lighter. As a result, the joint device has lesser inertia and is suitable for handling production material with shorter cycle times than a conventional handling apparatus. This makes the handling apparatus in accordance with the present disclosure preferably suitable for faster handling steps and for use within a region of the plant where, for example, there are limitations on the available installation space.

In a preferred embodiment of the present disclosure, it can be in particular advantageous if the handling apparatus on the joint device and/or on the supporting device is devoid of a drive motor for a jointed arm portion. In particular, a drive motor of the drive device is not positioned on the supporting device and/or the joint device. For example, as will be discussed below, a drive motor is accommodated in a zone that is separated from a further zone by a separating element of the handling system, in which the supporting device and/or the joint device are positioned, wherein the latter zone has a higher degree of cleanliness than the former zone. By eliminating the drive motor on the joint device and/or supporting device, installation space and weight can be saved in practice, resulting in a more compact configuration and lesser inertia for shorter cycle times with the handling apparatus.

It can be advantageous if the handling apparatus on the joint device and/or on the supporting device is devoid of a connecting line for a drive motor on the joint device and on the supporting device. It is advantageous, in particular, if no such connecting line (e.g., electrical and/or pneumatic) is passed through the supporting device and the joint device. Eliminating the need for connecting lines simplifies the design configuration of the handling apparatus. Furthermore, there are no connecting lines that are subject to loads resulting from the rotary movement of the jointed arm portion and the tool, wherein such loads occur in particular at joint connections. By eliminating the number of connecting lines, the reliability of the handling apparatus can be increased.

Because a lower weight and a more compact installation space can be achieved compared to a conventional handling apparatus, the use of a pharmaceutically compliant material in the handling apparatus in accordance with the present disclosure presents no difficulties whatsoever. In particular, stainless steel grade 316L can be used as a material that meets the requirements for cleanability of the handling apparatus.

Alternatively or additionally, a pharmaceutically compliant plastics material can be used, which keeps the weight low and can prove even more advantageous for short cycle times.

To reduce the mass and/or the moment of inertia at the jointed arm portions, components, such as covers of drive elements (e.g., housing parts of the supporting device and/or the transmission device(s)), can be made from the plastics material, in particular for use in a higher performance class.

With regard to ease of cleaning, it is also advantageous if moving components are encapsulated or enclosed as much as possible, and if, in the region of joints, there is a seal between parts of the handling apparatus that move relative to one another. For this reason, it is advantageous if the first transmission device is positioned in the first jointed arm portion housing, as mentioned.

For example, the first jointed arm portion housing can comprise a first housing part and a second housing part, resulting in a simple design configuration. The first jointed arm portion housing comprises, for example, a sealing device arranged between the two housing parts, wherein the housing parts are sealed relative to one another preferably in a pharmaceutically compliant manner. The pharmaceutically compliant seal is specifically configured to allow cleaning with a cleaning fluid, such as water, by rinsing or spray-washing. Preferably, the seal allows the handling apparatus to be exposed to a VHP cycle in which the handling apparatus is exposed to a decontamination atmosphere (for example, H₂O₂). Preferably, this allows the handling apparatus to comply with Good Manufacturing Practice (GMP) requirements, Annex 1.

The first housing part is, for example, plate-shaped, and the second housing part is, for example, hood-shaped. For example, one edge of the second housing part is attached to the first housing part with the interposition of a sealing device.

It is advantageous if the supporting device comprises or forms a supporting device housing in which the first drive element and the second drive element are partially arranged, wherein the drive elements are passed through at least one through-opening of the supporting device housing. Preferably, the supporting device housing offers the possibility of encapsulating the drive elements that are at least partially arranged therein.

It is advantageous if the first drive element and/or the second drive element is/are rotationally sealed relative to the supporting device housing by means of a sealing device. For example, the corresponding drive element is sealed relative to an edge of the at least one through-opening via a rotary sealing element, such as a double wiper.

The supporting device housing can, for example, comprise a first housing part and a second housing part. For example, the first housing part is plate-shaped, and the second housing part is hood-shaped. It is conceivable for the supporting device housing to comprise walls that are positioned between the two housing parts. For example, opposing end walls are provided, wherein the at least one through-opening is formed in one end wall. An intermediate wall may be provided in the supporting device housing, which serves for drive element bearing purposes.

The supporting device housing preferably comprises a sealing device, which is arranged, for example, between the two housing parts or between the end walls and/or the intermediate wall and one of the housing parts.

The supporting device housing is preferably sealed in a pharmaceutically compliant manner via the sealing device in order to improve the cleaning properties, wherein, advantageously, VHP-compliance obtains.

With regard to a compact design and simple construction, it can be advantageous if the first drive element and the second drive element are aligned coaxially with one another. Accordingly, the second drive element can be rotatable about the first axis of rotation.

Advantageously, the first drive element and the second drive element can be rotated independently of one another about the first axis of rotation.

It can be advantageous, for example, if the first drive element forms a sleeve or a hollow shaft through which the second drive element is guided, or vice versa. In practice, a design proves advantageous in which the first drive element is the sleeve or the hollow shaft.

The supporting device preferably comprises at least one bearing device, wherein the first drive element is rotatably mounted on the supporting device and/or the second drive element is rotatably mounted on the supporting device via the at least one bearing device. Advantageously, two bearing devices are provided, wherein one bearing device is assigned to the first drive element and one to the second drive element. It can be advantageous, for example, if the first drive element is mounted on one of the end walls, and the second drive element is mounted on an intermediate wall of the supporting device housing. Accordingly, walls of the supporting device housing can form bearing supports on which the corresponding bearing devices are arranged.

It can further be advantageous if the handling apparatus comprises a bearing device via which the first drive element and the second drive element are rotatably mounted on one another. This is particularly advantageous when the drive elements are coaxially aligned, wherein the bearing device is positioned, for example, between the drive elements.

The at least one bearing device of the supporting device and/or the last-mentioned bearing device may be of different designs. In particular, rolling bearings or plain bearings are conceivable, wherein the person skilled in the art will select the appropriate bearing depending upon requirements. For rotatable components of the handling apparatus, a radial bearing is provided in particular. Alternatively or additionally, an axial bearing is conceivable. The bearing device can be single-segmented or multi-segmented. A multi-segmented bearing device comprises, for example, two or more bearing elements arranged at a distance from one another—for example, bearing rings. The same can apply to all bearing devices mentioned and described in the present patent application.

As mentioned, the supporting device is advantageously devoid of a drive motor. Coupling elements, for example, can be provided to transmit a driving force to the first and/or second drive element.

In a preferred embodiment of the present disclosure, for example, a first coupling element associated with the first drive element and a second coupling element associated with the second drive element are provided, wherein the coupling elements, which can preferably be driven independently of one another by the at least one drive device, engage in the supporting device housing and are coupled therein to the respective drive element. The coupling elements can preferably be driven independently of one another by means of different drive motors of the drive device. Due to the coupling elements, the drive motors can be arranged in particular outside the supporting device housing. The coupling elements, for example, transmit a driving force from drive motors arranged in a substructure of the handling system within a zone that is separated from the zone in which the supporting device is arranged by a separating element. For example, the latter zone is of a higher cleanliness class than the former zone. Arranging the drive motors outside the latter zone (for example, in a machine substructure) allows, for example, the drive motors to be designed to be larger and therefore more robust, which is not possible when positioning the drive motors in the supporting device and in the joint device as in a conventional handling apparatus due to space and weight constraints. This increases the reliability of the handling apparatus.

The coupling elements can preferably be driven in rotation, wherein, in particular, a respective bearing device is provided for the rotary movement.

The coupling elements can be coupled to the drive elements, for example, via a gear connection. For example, meshing bevel gears prove advantageous for a compact design.

The coupling elements are preferably aligned coaxially with one another.

It may be provided for the first coupling element to be or form a hollow shaft through which the second coupling element is guided, or vice versa. A bearing device may be provided by which the coupling elements are rotatably mounted on one another.

In practice, it may prove advantageous if the first transmission device is or comprises a gear transmission, wherein two or more gears of the transmission are provided. The gear transmission can, in particular, be a gear drive.

Alternatively, the first transmission device can be configured differently—for example, as a belt drive.

With regard to reliable functioning of the handling apparatus, it is advantageous if the first jointed arm portion comprises a bearing device by which the first output element is rotatably mounted relative to the first jointed arm portion. The first output element can be driven by the transmission device. A driving force can be used to move the tool.

In a preferred embodiment of the present disclosure, the versatility of the handling apparatus can be increased by the joint device comprising a second jointed arm portion.

The second jointed arm portion is preferably rotatable relative to the first jointed arm portion about the second axis of rotation, wherein the first output element is connected in a rotationally fixed manner to the first jointed arm portion. The tool can be rotatably connected to the second jointed arm portion about a third axis of rotation. The handling apparatus can comprise a third drive element that is operatively connected to the tool for rotation about the third axis of rotation. The handling apparatus is upgraded by the addition of the second jointed arm portion and the additional third axis of rotation, providing an extra possibility of movement. The tool can be rotated via the third drive element, wherein the driving force can be transmitted to the tool in particular through the first jointed arm portion and the second jointed arm portion.

The first jointed arm portion and the second jointed arm portion can, for example, be substantially of the same length. Alternatively, it can be provided for the jointed arm portions to have different lengths, wherein the first jointed arm portion can be shorter than the second jointed arm portion, or vice versa.

Advantageously, the third drive element is held on the supporting device and can be driven in rotation about an axis. The axis in question can, in particular, be the first axis of rotation.

The third drive element can, for example, be at least partially arranged on the supporting device housing.

Preferably, the third drive element is aligned coaxially with the first drive element and/or the second drive element and is rotatable about the first axis of rotation, in particular independently of the first drive element and/or the second drive element.

In a structurally simple and compact design, the third drive element is configured, for example, as a drive shaft that is passed through the second drive element and/or first drive element, which is configured as a hollow shaft or sleeve. For example, the third drive element runs inside the second drive element, which in turn runs through the first drive element.

The supporting device preferably comprises a bearing device via which the third drive element is rotatably mounted about the first axis of rotation.

Alternatively or additionally, the handling apparatus comprises a bearing device via which the third drive element is rotatably mounted on the second drive element and/or on the first drive element.

The possibility of driving the drive elements via coupling elements was already discussed earlier. Correspondingly, it may be advantageous if the handling apparatus comprises a third coupling element associated with the third drive element and which engages in the supporting device housing and is coupled therein to the third drive element, wherein the third coupling element is preferably able to be driven independently of the first coupling element and the second coupling element by means of a drive motor of the drive device. The third coupling element is guided, for example, through the separating element into a substructure of the handling system in which a drive motor for the third drive element is arranged.

The third coupling element, for example, can be driven by rotation. It may be provided for a bearing device to be available for bearing the third coupling element.

The third coupling element is advantageously coupled to the third drive element via a toothed connection, in particular via meshing bevel gears.

In an advantageous embodiment of the present disclosure, the third coupling element is aligned parallel to the first coupling element and/or to the second coupling element.

It may be provided for the third coupling element to be aligned coaxially with the first coupling element and/or the second coupling element. It may be provided for the first coupling element and/or the second coupling element to be or form a hollow shaft through which the third coupling element is passed, or vice versa.

It can be particularly advantageous if the handling apparatus comprises a second transmission device, which is coupled to the third drive element, and a second output element via which the second transmission device is coupled to a third transmission device arranged on the second jointed arm portion and operatively connected to the tool via a power transmission element. The driving force of the third drive element can be indirectly transmitted to the tool via the second transmission device and the third transmission device, viz., through the joint device. This eliminates the need for a drive motor for the tool on the supporting device and on the joint device.

Advantageously, the second transmission device is arranged in the first jointed arm portion housing. For example, the second transmission device is positioned next to the first transmission device, and the first jointed arm portion housing is sealed as explained above.

The second transmission device can, for example, be or comprise a wheel transmission, in particular a gear drive.

Alternatively, the second transmission device can be configured differently—for example, as a belt drive.

It can be advantageous if the first transmission device and the second transmission device are of identical or functionally equivalent designs.

The first output element is, for example, aligned coaxially with the second output element, so that both output elements can be rotated about the second axis of rotation.

The first output element can form a sleeve or hollow shaft through which the second output element is guided. This makes it possible to give the joint device a compact design.

The handling apparatus advantageously comprises a bearing device via which the second output element and the first output element are mounted on one another.

The second jointed arm portion preferably comprises or forms a second jointed arm portion housing in which the third transmission device is accommodated. It is possible, in particular, to encapsulate the third transmission device, as has already been explained in connection with the first transmission device on the first jointed arm portion. Reference is made to the aforementioned advantages.

For example, the second jointed arm portion housing comprises a first housing part and a second housing part, which may be plate-shaped or hood-shaped, for example.

The jointed arm portion housing preferably comprises a sealing device between the housing parts, wherein the housing parts are sealed relative to one another preferably in a pharmaceutically compliant manner. For example, an edge of the second housing part is attached to the first housing part via the insertion of the sealing device. The sealing device is preferably designed such that spray cleaning, rinse cleaning, and decontamination via a VHP cycle can advantageously be carried out on the second jointed arm portion housing in the same way as was explained in connection with the first jointed arm portion housing.

The second jointed arm portion housing is advantageously rotationally sealed relative to the first jointed arm portion housing by means of a sealing device. For this purpose, a rotary sealing element, e.g., a double wiper, is provided between the two housings.

Advantageously, the joint device is devoid of axial movements of the drive elements relative to the first jointed arm portion and/or the output elements relative to the first jointed arm portion and/or relative to the second jointed arm portion.

In practical implementation of the handling apparatus, it proves advantageous if the third transmission device is or comprises a belt drive comprising: a drive gear connected in a rotationally fixed manner to the second output element; an output gear connected in a rotationally fixed manner to the power transmission element; and a belt element running over these two gears. The belt element is preferably a toothed belt. The belt drive allows for a compact design while simultaneously reducing the mass of the second jointed arm portion.

A tensioning gear for adjusting the belt tension is advantageously provided.

Alternatively, the third transmission device can be configured differently, e.g., as a gear transmission, in particular as a gear drive.

The first axis of rotation, the second axis of rotation, and the third axis of rotation can, for example, be aligned parallel to one another in pairs.

The tool is advantageously configured with multiple positions for simultaneously processing a plurality of preferably identical copies of the production material. Positions on the tool, such as receptacles for the production material, are preferably arranged equidistantly from one another.

Various production materials have already been discussed. In a preferred embodiment, the production material consists of closing elements for pharmaceutical containers. However, the present disclosure is not limited to this. Accordingly, it can be advantageous if the handling apparatus is a feeding apparatus for closing elements for pharmaceutical containers, wherein the tool comprises a receiving body for the closing elements.

It shall be understood that the present disclosure is not limited to the application of the handling apparatus for the application with closing elements described herein.

Possible applications of the handling apparatus and handling system in accordance with the present disclosure include, for example, any one or more of the following tasks in a container processing plant: container feeding (e.g., inserting/removing syringes or vials into a transport system), transferring packaging materials (e.g., repositioning syringes or vials), use in a sealing gas station, filling needle movement, IPC processes (transferring containers to scales), transferring filling needles from a production position to a CIP/SIP (clean in place, sterilization in place) position and back, transferring filling needles from a setup position to a production position and back, random removal of containers from a transport system, handling of culture medium carriers such as Petri dishes (biomonitoring), handling of sterile tools, moving container closures (crimp caps, needle guards, etc.).

It may be provided for the first jointed arm portion to be rotatable relative to the supporting device over a rotation angle of at least 180°. The same can apply to a rotation angle of the second jointed arm portion relative to the first jointed arm portion. The same can apply to a rotation angle of the tool relative to the first jointed arm portion or to the second jointed arm portion.

Depending upon the design of the handling apparatus, specifically the transmission devices and/or drive motors, it may be provided for the axes of rotation of the first and/or second jointed arm portion and/or of the tool to be controlled and operated independently of one another. In practice, however, it may also be possible that, due to the design of the transmission devices and/or drive motors, due to starting elements and/or internal friction, there may be a dependency of the rotational movements about two or more of the axes of rotation. This is why in practice it may, for example, be provided or necessary that two or more drive motors be active in order to perform a pivoting motion about only one axis of rotation in order to compensate for the aforementioned dependency of the rotational movements.

The object mentioned at the outset is further achieved by a handling system in accordance with the present disclosure for pharmaceutical production material, comprising a frame that can be placed on a set-down surface and that comprises an in particular plate-shaped separating element that separates a first zone from a second zone, wherein the first zone is of a higher cleanliness class than the second zone, a handling apparatus of the type described above, wherein the supporting device and the joint device are arranged in the first zone, wherein the at least one drive device is arranged in the second zone, wherein at least one coupling element of the handling apparatus is passed through a through-opening of the separating element.

The advantages already mentioned in connection with the handling apparatus in accordance with the present disclosure can also be achieved with the handling system. Reference is made to what has been stated above.

Advantageous embodiments of the handling system in accordance with the present disclosure result from advantageous embodiments of the handling apparatus in accordance with the present disclosure. In this regard too, reference is made to the above statements.

With the handling system in accordance with the present disclosure, it is advantageous that the drive device, in particular a drive motor, is arranged in the second zone. The driving force is transmitted via the coupling element through the separating element into the region of the first zone in order to drive the corresponding drive element there. As explained above, the supporting device and/or the joint device is advantageously devoid of a drive motor and/or connecting lines therefor.

The first zone can be a cleanroom—for example, of class A, B, C, or D. The separating element can be covered by machine guard with appropriate walls and/or by an isolator device.

The separating element can, for example, be a tabletop of the frame.

The handling system can, for example, comprise an in particular column-shaped carrying device in which the at least one coupling element is arranged and which extends through or engages in the through-opening or rests against the edge of the through-opening in the first zone. Preferably, the handling system comprises a sealing device for sealing the through-opening between the first zone and the second zone.

The carrying device forms, for example, a housing or enclosure for the at least one coupling element, preferably the three coupling elements mentioned above.

The at least one coupling element or the carrying device is preferably devoid of a linear movement, in particular a lifting movement, through the through-opening. This prevents a transfer of germs from the second zone to the first zone and thus increases the hygienic standard of the handling system.

The handling apparatus and handling system preferably only use rotary movements and corresponding rotary seals. Translational movements, such as lifting movements, are preferably not present in order to avoid corresponding particle carryover as a result of the translational movements. This particularly prevents particles from entering the first zone.

In a preferred embodiment of the present disclosure, the handling system advantageously comprises at least one transport path for closing elements and a holding element for containers to be closed. Depending upon the type of container, the holding element can, for example, be a set-down element for stable containers or a gripping element for non-stable containers.

In the last-mentioned advantageous embodiment, the tool is in particular movable from a receiving position to a transfer position, and vice versa, wherein closing elements in the receiving position are received with the tool and in the transfer position are positioned above the container to be closed.

Position and orientation details here refer to an intended use of the handling system and handling apparatus.

In the embodiment mentioned above, the tool accommodates the closing elements, which are positioned above the containers. The closing elements can be placed on or in the containers using a push element, such as a plunger, to close them.

The tool is advantageously movable such that the closing elements have opposite orientations in the receiving position and in the transfer position. In particular, the closing elements are reversed. In the receiving position, for example, the closing elements can be oriented upwards with a side facing the product filled. Any adhesions are removed via a gas flow (for example, with laminar flow, LF). In the transfer position, the side facing the product is oriented downwards.

It can be advantageous if the tool is movable such that the closing elements, depending upon the design, in particular the size, of the containers to be closed, are received at the same receiving position and can assume different transfer positions, which are arranged along a container axis above the containers, wherein containers of different design have identical container axes. On the receiving side, the closing elements can be fed at the same position. On the transfer side, for example, the closing elements are positioned higher the larger the containers are. However, the closing elements can be positioned along the same axis, in particular a container axis, regardless of size. As a result, push elements can be moved along the same axis regardless of size in order to close containers of different sizes with the closing elements.

A plant in accordance with the present disclosure for processing pharmaceutical containers comprises a handling system of the type described above, wherein the handling system comprises or forms a closing station for the containers, and wherein at least one further processing station for the containers is provided—for example, a filling station. For example, closing elements are fed to the containers filled with a product, and the closing elements are placed on or in the containers by means of push elements.

The plant in accordance with the present disclosure then exhibits the advantages and effects mentioned in connection with the handling apparatus and the handling system. Advantageous embodiments of the plant result from advantageous embodiments of the handling apparatus and handling system.

FIG. 1 shows, in a schematic representation, an advantageous embodiment of the plant in accordance with the present disclosure for processing pharmaceutical containers, which is denoted as a whole by reference sign 100. In the present case, the containers 102 are for example vials 104 which are shown in FIGS. 10 and 12. However, the present disclosure is not limited to this type of container.

The plant 100 allows the containers 102 to be processed at a plurality of processing stations 106. The processing stations 106 comprise, for example, at least one weighing station 108 for tare weighing and gross weighing of the containers in an empty or filled state, a filling station 110 for filling the containers 102 with a product, and a closing station 112. At the closing station 112, the containers 102 can be closed using closing elements 114.

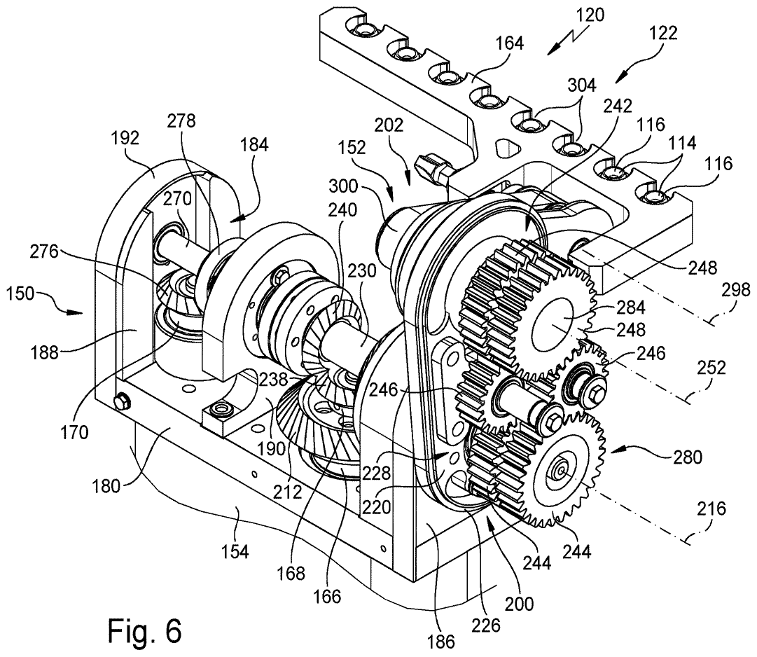

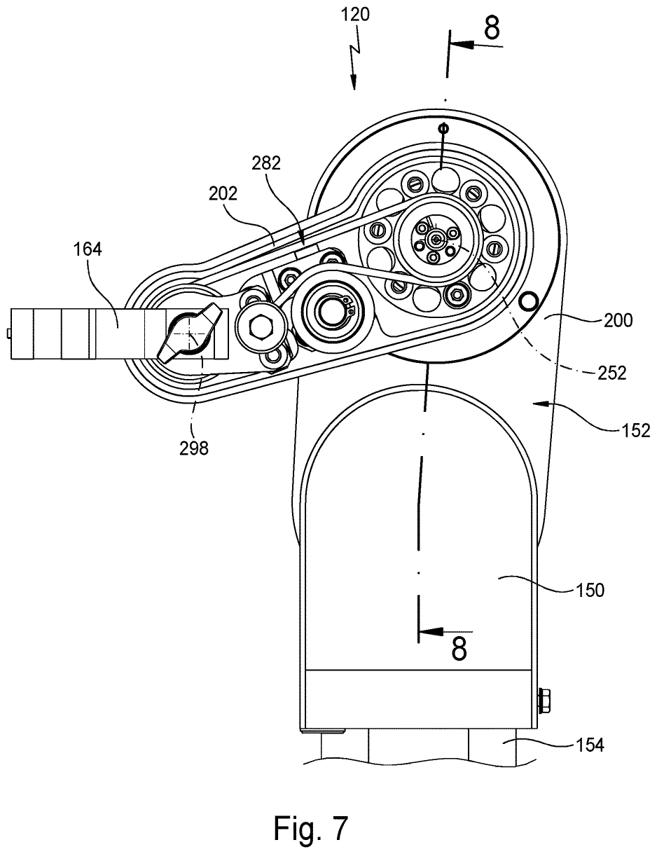

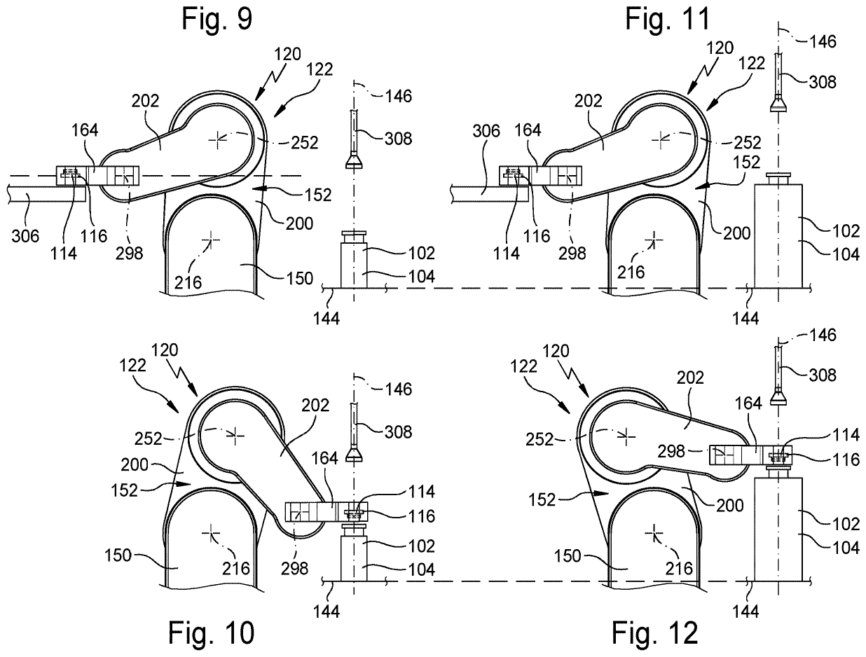

The closing elements 114 are shown in FIGS. 9 to 12 and in FIG. 6. The closing elements 114 are part of pharmaceutical production material 116 in the present case. From what has been said, it shall be understood that the present disclosure is not limited to closing elements 114 as production material 116.

The plant 100 comprises the handling system 118 in accordance with the present disclosure in a preferred embodiment, which in turn comprises the handling apparatus 120 in accordance with the present disclosure in a preferred embodiment. The handling apparatus 120 is configured here as a feeding apparatus 122 for the closing elements 114. The handling apparatus 120 also comprises a closing apparatus 124 for pressing the closing elements 114 onto the containers 102 and a storage apparatus 126 for storing the closing elements 114. The closing apparatus 124 and storage apparatus 126 will be discussed below.

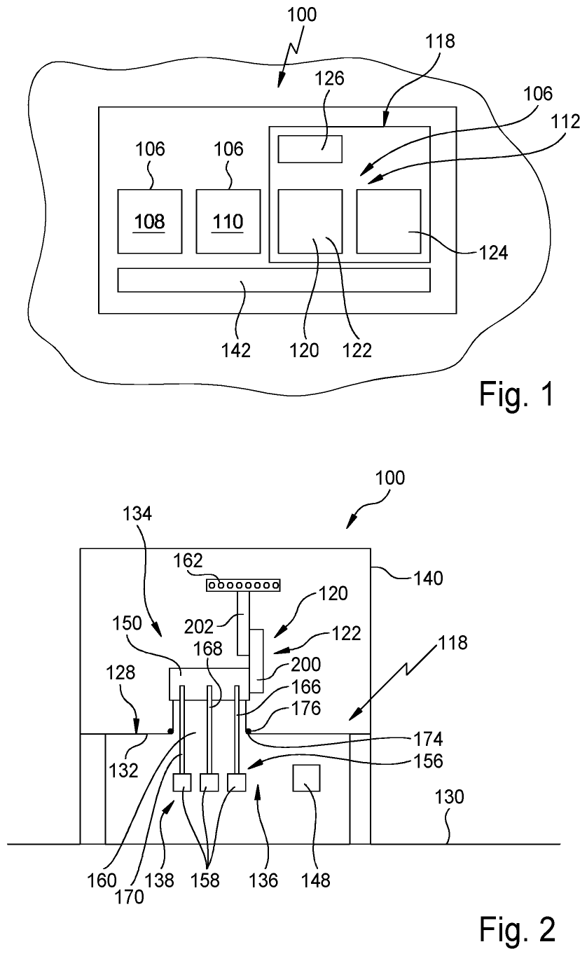

As can be seen, for example, in FIG. 2, the handling system 118 comprises a frame 128 which can be positioned on a set-down surface 130 of a room—for example, a laboratory. The frame 128 comprises a separating element 132, which in the present case is plate-shaped and can in particular form a set-down element for processing stations 106. The separating element 132 can in particular be a tabletop of the frame 128.

The separating element 132 separates a first zone 134 from a second zone 136. The cleanliness class of the first zone 134 is higher than the cleanliness class of the second zone 136. In particular, the first zone 134 is part of a cleanroom—for example, of cleanliness class A, B, C, or D. The second zone 136 is located below the separating element 132 and is thus in the substructure 138 of the handling system 118, which at the same time is also a substructure 138 of the plant 100.

The first zone 134 is preferably covered by a machine guard or an isolator device 140, with which the cleanliness class can be ensured.

Within the first zone 134, the containers 102 can be transported along the processing stations 106 by means of a transport system 142. In the present case, the vials 104 are stable containers 102, so that the transport system 142 comprises a set-down element 144 (FIGS. 10 and 12). The set-down element 144 is formed, for example, by a conveyor belt, although the present disclosure is not limited to this. Instead of a belt transport, for example a rake transport or transport with a robotic apparatus can be provided.

In the present exemplary embodiment of the handling system 118, the containers 102 can be positioned on the set-down element 144 regardless of their size such that the container axes 146 are fixed in space. For processing on the handling system 118, the containers 102 also have defined positions along the transport system 142.

A control apparatus 148 is provided for controlling the operation of the plant 100. The control apparatus 148 can at the same time be a control apparatus of the handling system 118 and of the handling apparatus 120. Advantageously, it is operatively connected to all controllable components of the plant 100.

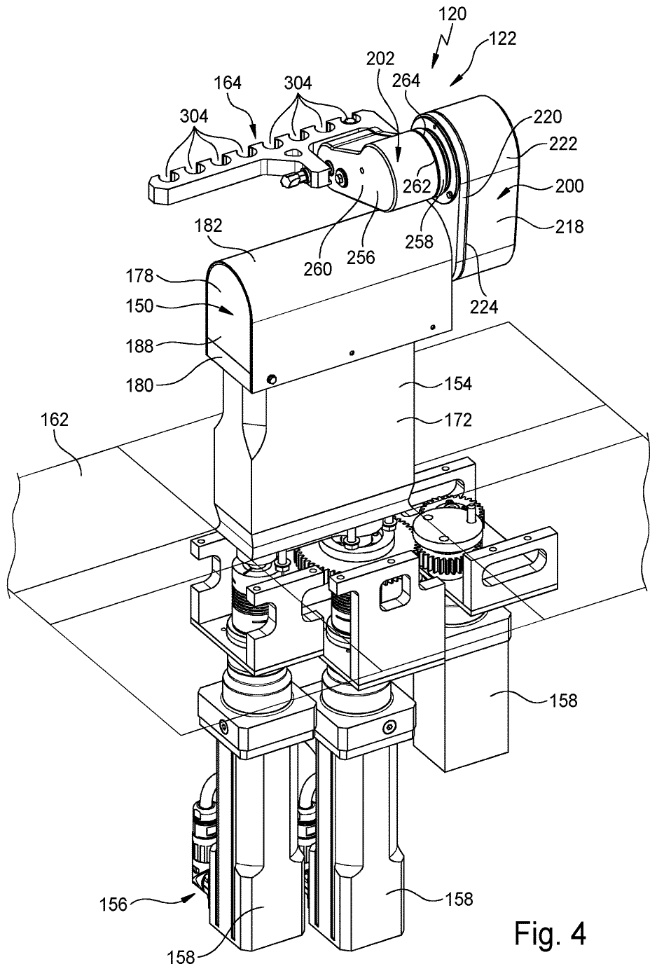

As can be seen in particular in FIGS. 2 and 4, the handling apparatus 120 comprises a supporting device 150, a joint device 152, a carrying device 154, and a drive device 156.

The drive device 156 comprises drive units, in the present case configured as drive motors 158. The drive motors 158 are, for example, servo motors or stepper motors. The drive motors 158 can, for example, comprise an integrated or attached transmission, which provides the respective optimal gear ratio of the respective motor speed for the respective joint and/or the respective transmission device.

In the present case, the drive device 156 is arranged in the second zone 136 and thus in the substructure 138.

In the present case, a through-opening 160 is formed in the separating element 132 (FIG. 2). A plane 162 formed by the separating element 132 is shown schematically in FIG. 4.

The drive motors 158 are, for example, held on the underside of the separating element 132 or otherwise on the frame 128.

The drive motors 158 serve to drive, in rotation, the joint device 152 and a tool 164 held on the joint device 152 for the closing elements 114. For this purpose, a respective drive motor 158 drives a coupling element 166, 168, or 170. The coupling elements 166, 168, and 170 are passed through the through-opening 160 and protrude into the first zone 134. The driving forces are thereby provided in the handling system 118 by the drive motors 158 arranged in the substructure 138.

In contrast, no drive motors are arranged on or in the supporting device 150 and on or in the joint device 152. Also, no connecting lines, e.g., electrical lines and/or pneumatic lines, are arranged in the supporting device 150 and in the joint device 152 and in particular are not passed through said devices 150, 152.

Overall, this results in a compact design for the handling apparatus 120 with a relatively low mass compared to conventional handling apparatuses. Due to its compact design and low mass, this makes it possible to increase the work cycle achievable with the handling apparatus 120. At the same time, it is possible to use the handling apparatus 120 in regions of the plant 100 where there is little installation space available.

In the present exemplary embodiment, the supporting device 150 virtually forms a base for the joint device 152. In the present example, the supporting device 150 is mounted on top of the carrying device 154, which is column-shaped. The carrying device 154 forms an enclosure 172 for the coupling elements 166, 168, and 170 and encloses them in a circumferential direction.

In a different embodiment, the supporting device 150 could, for example, be arranged directly on the separating element 132, wherein the carrying device 154 is dispensed with.

In the present case, the carrying device 154 is located at an edge 174 of the through-opening 160 (FIG. 2). Alternatively, it could be provided, for example, for the carrying device 154 to engage in or extend through the through-opening 160.

For the purpose of zone separation, it can be advantageous if a sealing device 176 is present between the first zone 134 and the second zone 136. For example, the sealing device 176 forms a seal between the carrying device 154 and the edge 174 of the through-opening 160. The sealing device 176 is shown schematically in FIG. 2.

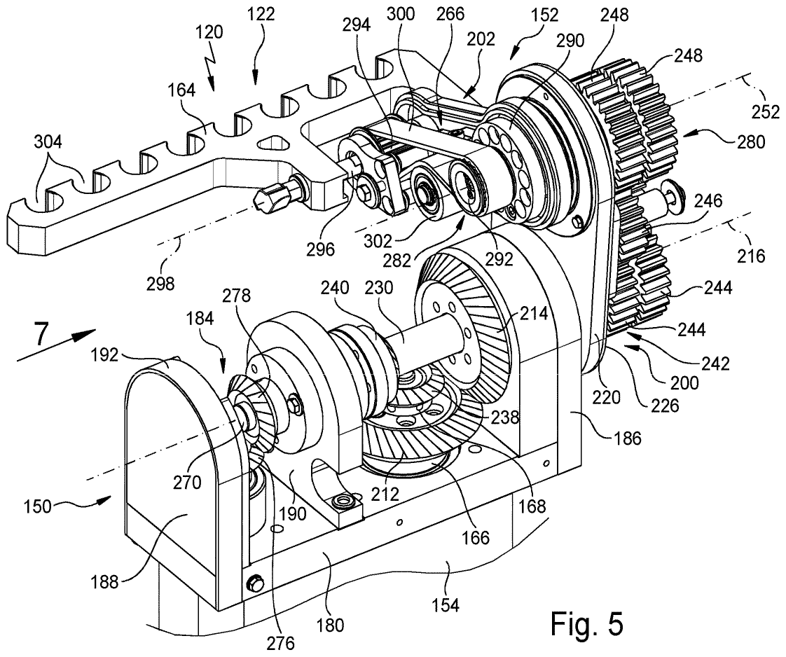

As can be seen, for example, from FIGS. 2 to 6, the supporting device 150 in the present exemplary embodiment comprises a supporting device housing 178 (hereafter: housing 178). The housing 178 is fixed to the carrying device 154 at the top.

The housing 178 comprises a housing part 180, which is plate-shaped in the present example and forms a bottom of the housing 178, and a further housing part 182, which is hood-shaped in the present example. The housing part 182 overlaps the housing part 180, and together they enclose a receiving space 184.

The housing 178 further comprises end walls 186, 188 at opposite ends and, in the present case, an intermediate wall 190 arranged between the end walls 186, 188.

A sealing device 192 seals the housing 178, in the present case between the housing part 182 and the walls 186, 188, and 190. The housing 178 is therefore sealed in particular in a pharmaceutically compliant manner, so that it is possible to spray-wash or rinse the housing 178 for cleaning. The housing 178 can be subjected to a VHP cycle, in particular with H₂O₂.

The coupling elements 166, 168, and 170 engage through the housing part 180 into the receiving chamber 184.

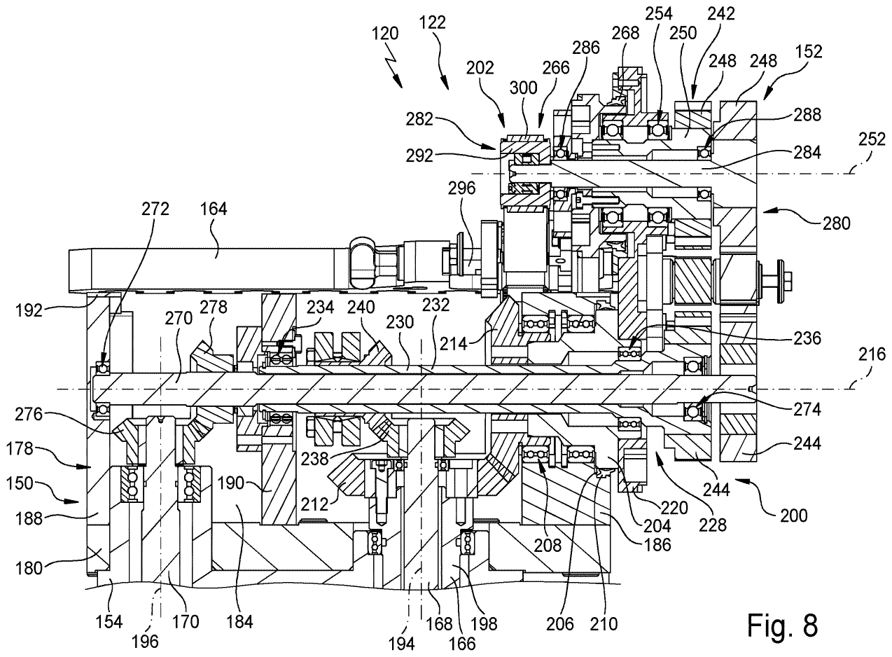

In the present case, the coupling elements 166, 168, and 170 are rotatable about axes of rotation 194 and 196 (FIG. 8). A rotatable bearing exists at the carrying device 154.

There is in particular no translational movement of the coupling elements 166, 168, and 170. Driving forces of the drive motors 158 are transmitted to the joint device 152 solely by rotary movements. By avoiding translational movements, in particular between the first zone 134 and the second zone 136, the risk of particles being introduced in particular into the first zone 134 is reduced or advantageously eliminated, so that the hygienic standard of the handling apparatus 120 is high.

In the present exemplary embodiment, the coupling elements 166 and 168 are aligned coaxially with one another and can be rotated independently of one another about the axis of rotation 194. Here, the (first) coupling element 166 is a hollow shaft 198 through which the (second) coupling element 168 extends.

The (third) coupling element 170 is arranged parallel to the two other coupling elements 166, 168.

In the present example, the joint device 152 forms a jointed arm with a first jointed arm portion 200, which is rotatable relative to the supporting device 150. The coupling element 166 allows the jointed arm portion 200 to be rotated relative to the supporting device 150.

The jointed arm further comprises a second jointed arm portion 202, which is rotatably held on the first jointed arm portion 200. The coupling element 168 allows the second jointed arm portion 202 to be rotated relative to the first jointed arm portion 200.

The tool 164 is rotatably held on the second jointed arm portion 202. The coupling element 170 allows the tool 164 to be rotated relative to the second jointed arm portion 202.

In the present exemplary embodiment, the first jointed arm portion 200 and the second jointed arm portion 202 are substantially of the same length.

The following describes how the respective driving force provided by the drive motors 158 via the coupling elements 166 to 170 is transmitted for the aforementioned rotary movements.

To rotate the first jointed arm portion 200, the handling apparatus 120 comprises a (first) drive element 204. In the present case, the drive element 204 is configured as a sleeve which is inserted into a through-opening 206 of the housing 178. The through-opening 206 is formed in the end wall 186.

The drive element 204 and the bevel gear 214 are rotatably mounted on the end wall 186 of the housing 178 via a bearing device 208. The bearing device 208 is configured as a rolling bearing and in the present case comprises two bearing rings.

A sealing device 210 is provided which provides a rotary seal between the drive element 204 and the end wall 186 of the housing. The sealing device 210 is configured as a rotary sealing element—for example, as a double wiper.

In the present case, the drive element 204 is coupled to the coupling element 166 via meshing bevel gears 212 at the coupling element 166 and via meshing bevel gears 214 at the drive element 204. By rotating the coupling element 166, the drive element 204 is driven to rotate about a (first) axis of rotation 216, which is aligned perpendicular to the axis of rotation 194.

The drive element 204 is connected in a rotationally fixed manner to the first jointed arm portion 200. The drive element 204, for example, rests like a flange against the jointed arm portion 200 (FIG. 8).

In the present exemplary embodiment, the first jointed arm portion 200 comprises a first jointed arm portion housing 218 (hereafter: housing 218). In the present case, the housing 218 comprises a housing part 220 and a housing part 222. Housing part 220 is connected in a rotationally fixed manner to the drive element 204 and is plate-shaped. Housing part 222 is hood-shaped.

An edge 224 of housing part 222 is joined to housing part 220 with the interposition of a sealing device 226. The sealing device 226 seals the housing 218 to render a pharmaceutically compliant design, in particular for cleaning purposes and resistance to VHP cycles. The housing 218 encloses a receiving space 228.

With the coupling element 166 driven, the first jointed arm portion 200 is rotated about the axis of rotation 216. The second jointed arm portion 202 and the tool 164 held thereon are also rotated about the axis of rotation 216.

A (second) drive element 230 is provided to drive the second jointed arm portion 202. The drive element 230 passes through the sleeve of the drive element 204 and is aligned coaxially therewith. The drive element 230 is configured as a hollow shaft 232.

The drive element 230 is rotatably mounted on the intermediate wall 190 via a bearing device 234—in the present case, a rolling bearing.

A further bearing device 236 is provided, by means of which the drive element 230 is rotatably mounted on the drive element 204. The bearing device 236 is configured as a rolling bearing.

The second coupling element 168 couples the drive element 230 via bevel gears 238 to the coupling element 168 and via bevel gears 240 to the drive element 230. With the coupling element 168 driven, the drive element 230 rotates about the axis of rotation 216.

To transmit the driving force to the second jointed arm portion 202, the handling apparatus 120 comprises a (first) transmission device 242. The transmission device 242 is accommodated in the housing 218. The transmission device 242 is a gear transmission, in particular a gear drive.

A first gear 244 is connected to the drive element 230 in a rotationally fixed manner. The gear 244 meshes with a further gear 246, which in turn meshes with a third gear 248, which is connected in a rotationally fixed manner to a (first) output element 250. The output element 250 defines a (second) axis of rotation 252, which in the present case is aligned parallel to the axis of rotation 216.

The number of teeth on the gears 244 and 248 is identical in the present case, so that neither a translation nor a reduction of the speed of the drive element 230 takes place.

The output element 250 is rotatably mounted on the jointed arm portion 200, in particular its housing part 220, via a bearing device 254. In the present case, the bearing device 254 is configured as a rolling bearing and comprises two bearing rings arranged at a distance from one another.

The output element 250 extends through the housing part 220 and is connected in a rotationally fixed manner to the second jointed arm portion 202.

The second jointed arm portion 202 comprises a (second) jointed arm portion housing 256 (hereafter: housing 256). The housing 256 comprises a housing part 258 and another housing part 260.

Housing part 258 is plate-shaped, and housing part 260 is hood-shaped. An edge 262 of the housing part 260 is joined to the housing part 258 with the interposition of a sealing device 264. The sealing device 264 provides a sealing, which is in particular pharmaceutically compliant, of the housing 256 with regard to cleanability and the application of VHP cycles. The housing 256 forms a receiving space 266.

The jointed arm portions 200, 202 are rotationally sealed relative to one another. For this purpose, a sealing device 268 is provided, which forms a seal between housing part 260 and housing part 220 and is configured as a double wiper.

With the coupling element 168 driven, the driving force is transmitted via the drive element 204 and the transmission device 242 to the output element 250 and also to the jointed arm portion 202 for rotation about the axis of rotation 252.

To rotate the tool 164, the handling apparatus 120 comprises a (third) drive element 270. The drive element 270 is configured as a shaft that is aligned coaxially with the drive elements 204 and 230. The drive element 270 passes through the drive element 230.

The drive element 270 is rotatably mounted on the housing 178 via a bearing device 272, in the present case, in the form of a rolling bearing. In the present case, the bearing device 272 is arranged at the end wall 188.

In addition, a bearing device 274 is provided, by means of which the drive element 270 is rotatably mounted on the drive element 230.

To couple the drive element 270 to the coupling element 170, meshing bevel gears 276 are provided on the coupling element 170, and meshing bevel gears 278 are provided on the drive element 270 in the present case. When the coupling element 170 rotates about the axis of rotation 196, the drive element 270 rotates about the axis of rotation 216.

To transmit the driving force to the tool 164, the handling apparatus 120 comprises a (second) transmission device 280 and, moreover, a (third) transmission device 282.

The transmission device 280 is arranged in the housing 218 and is configured in the present case as a gear transmission and in particular a gear drive. The transmission devices 242 and 280 are functionally identical in construction and differ only in terms of the arrangement of the gears 244, 246, and 248 in the receiving space 228. The number of teeth on the gears 244 and 248 is identical in the present case as well, so that neither a translation nor a reduction of the speed of the drive element 270 takes place.

When it comes to the second transmission device 280, the gear 248 is connected in a rotationally fixed manner to a (second) output element 284. The output element 284 is configured to be coaxial with the output element 250 and rotatable relative to it. In this case, the output element 250 is configured as a sleeve through which the output element 283 is passed.

A bearing device 288 ensures a rotatable bearing of the output element 284 relative to the output element 250. A further bearing device 286 is provided for the bearing of the output element 284 on the second jointed arm portion 202. The bearing devices 286, 288 are rolling bearings in the present case. The bearing device 286 is mounted opposite a ring 290, which is connected in a rotationally fixed manner to the housing part 258.

The third transmission device 282 is arranged in the receiving space 266. The transmission device 282 is configured as a belt drive and in particular as a toothed belt drive in the present case.

A drive gear 292 is connected in a rotationally fixed manner to the output element 284 and is driven thereby. An output gear 294 is connected to a power transmission element 296 in a rotationally fixed manner.

The gears 292 and 294 have the same number of teeth in the present case, so that neither a translation nor a reduction of the speed takes place.

The power transmission element 296 defines a (third) axis of rotation 298, which is aligned parallel to the axes of rotation 252 and 216. The tool 164 is connected to the power transmission element 296—in the present case, by a screw connection. For this purpose, the power transmission element 296 extends from the housing 256. Preferably, the power transmission element 296 is rotationally sealed relative to the housing 256 via a rotary sealing element.

A toothed belt 300 of the transmission device 282 transmits the driving force by meshing with the gears 292, 294. Additionally, a tensioning gear 302 is provided, with which the tension of the toothed belt 300 can be adjusted.

When the coupling element 170 rotates, the drive element 270 is rotated about the axis of rotation 216. The driving force is transmitted via the transmission device 280 to the output element 284 for rotation about the axis of rotation 252. The driving force is furthermore transmitted via the transmission device 282 to rotate the power transmission element 296 and thus the tool 164 about the third axis of rotation 298.

Depending upon the design of the handling apparatus 118, specifically the transmission devices 242, 280, and/or 282, and/or the drive motors 158, it may be provided for the axes of rotation 216, 252, and 298 to be controllable and operable completely independently of one another. For example, when one drive motor 158 is activated, the other two drive motors 158 can be switched to passive/inactive mode. With sufficiently good bearing, this leads to the first jointed arm portion 200 being pivoted, while the angle of the jointed arm portion 202 and the tool 164 relative to the jointed arm portion 200 remains unchanged, to only the second jointed arm portion 202 being pivoted, while the angle of the tool 164 to the jointed arm portion 202 and the angle of the jointed arm portion 200 to the supporting device 150 remain unchanged, or to only the tool 164 being pivoted, while the jointed arm portions 200, 202 are not moved.

In practice, however, due to the design of the transmission devices 242, 280, and/or 282, and/or the drive motors 158, which cannot be switched completely freely, there may be a dependency of the rotational movements about two or more of the axes of rotation 216, 252, and 298 due to starting elements and/or internal friction. Friction effects from the different bearing devices can also contribute to this dependency.

This is why in practice it may, for example, be provided or necessary that two or more drive motors 158 be active in order to perform a pivoting motion about only one axis of rotation (for example, of the jointed arm portion 200, the jointed arm portion 202, or the tool 164), whereas the other angular positions of the jointed arm portions or tool relative to one another are not to change, as explained above. By activating two or more drive motors 158, the aforementioned dependencies can be compensated for, so that as a result only one of the axes of rotation 216, 252, and 298 is controlled.

Depending upon the design of the transmission devices and/or drive motors 158 and the frictional influences that may occur, the skilled person will be able to ensure a desired movement of the tool 164 by appropriately controlling the drive motors 158.

In the present case, the tool 164 serves to accommodate the closing elements 114. In the present case, the tool 164 has a plurality of receptacles 304—for example, eight in the present case.

When the handling system 118 is in operation, closing elements are fed back by the storage apparatus 126, which for this purpose may in particular have feed paths 306. Upstream of the feed paths 306, the storage apparatus 126 comprises, for example, a container for closing elements 114—for example, in the form of a conveyor pot.

The closing elements are transferred from the feed paths 306 into the receptacles 304 in a manner familiar to those skilled in the art and can be transported by the tool 164.

FIG. 9 illustrates this by way of example. In this process, the tool 164 assumes a receiving position in which the closing elements 114 are received. Their orientation is such that the side facing the product is directed upwards.

The plant 100 can provide an airflow, e.g., by means of LF (laminar flow), to act upon the closing elements 114 on the side facing the product and to blow off particles.

Starting from the receiving position, the tool 164 is then pivoted into a transfer position, which is shown in FIG. 10, by suitable control of the drive motors 158.

In the transfer position, the closing elements 114 are arranged above the containers 102 and are aligned with the respective container axes 146.

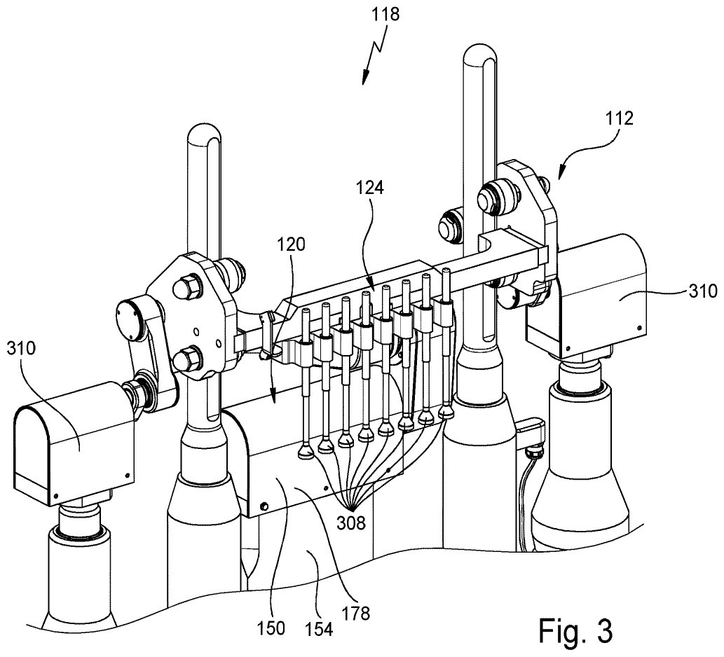

The closing apparatus 124 comprises push elements 308 (FIGS. 3 and 10), wherein each closing element 114 is assigned a push element 308. As a result of an axial movement of the push elements 308 along the container axis 146 by means of drive units 310 of the closing apparatus 124, the closing elements 114 are pushed out of the receptacles 304 and close the containers 102.

The handling system 118 is designed such that the receiving position is independent of the size of the containers 102. This is shown in FIGS. 9 and 11. FIGS. 9 and 11 show how the receiving position is identical for containers 102 of different sizes. This is advantageous because the position of the feed paths does not need to be changed, and no translational lifting movement needs to be performed from the substructure 138.

In the transfer position, the closing elements 114 are arranged at different positions depending upon the size of the containers 102, but always above the containers 102 on the container axes 146. This is shown in FIGS. 10 and 12. In the variant shown in FIG. 12, the containers 102 are larger compared to the situation in accordance with FIG. 10. However, in this case too, the closing elements 114 are aligned axially to the container axes 146 and can be pressed on by means of the push elements 308.

The required trajectory of the tool 164 to assume the correct receiving position and the correct transfer position can be ensured by means of suitable control of the joint device 152.

It shall be understood that the present disclosure is not limited to the application of the handling apparatus for the pick and place application described herein of closing elements.

In the present case, the axes of the coupling elements 166 to 170 are aligned perpendicularly to the set-down surface 130 and to the separating element 132, in particular vertically. The axes of rotation 216, 252, and 298 are aligned parallel to the set-down surface and the separating element, in particular horizontally.

In a different embodiment of the handling apparatus 120 in accordance with the present disclosure, different orientations of axes could be present. In contrast to the standing version of the handling apparatus 120 described herein, it is conceivable for the latter to be mounted in a suspended state—for example, on a side wall or on an upper wall of the plant 100.

The components of the handling system 118, in particular of the handling apparatus 120, which are exposed to the atmosphere of the first zone 134, are, as far as possible, made of a pharmaceutically compliant material that allows WIP applications and/or decontamination applications. For example, 316L-grade stainless steel is used. Alternatively or additionally, a plastics material can be used to reduce the mass and/or the inertia. For example, housings 178, 218, and/or 256 are made entirely or partially of the plastics material.

The handling system 118 allows the containers 102 to be closed in a cycled manner. The cycle time can be approximately 1 s to 2 s, for example. The eight-positions configuration allows for processing approximately 14,400 to 28,800 containers per hour. In practical implementation, for example, a cycle time of 1.2 s was achieved, with a processing of 24,000 containers per hour.

### LIST OF REFERENCE NUMERALS

100 Plant
102 Container
104 Vial
106 Processing station
108 Weighing station
110 Filling station
112 Closing station
114 Closing element
116 Production material
118 Handling system
120 Handling apparatus
122 Feeding apparatus
124 Closing apparatus
126 Storage apparatus
128 Frame
130 Set-down surface
132 Separating element
134 First zone
136 Second zone
138 Substructure
140 Machine guard
142 Transport system
144 Set-down element
146 Container axis
148 Control apparatus
150 Supporting device
152 Joint device
154 Carrying device
156 Drive device
158 Drive motor
160 Through-opening
162 Plane
164 Tool
166, 168, 170 Coupling element
172 Enclosure
174 Edge
176 Sealing device
178 Supporting device housing
180, 182 Housing part
184 Receiving space
186, 188 End wall
190 Intermediate wall
192 Sealing device
194, 196 Axis of rotation
198 Hollow shaft
200 First jointed arm portion
202 Second jointed arm portion
204 Drive element
206 Through-opening
208 Bearing device
210 Sealing device
212, 214 Bevel gear
216 First axis of rotation
218 First jointed arm portion housing
220, 222 Housing part
224 Edge
226 Sealing device
228 Receiving space
230 Second drive element
232 Hollow shaft
234, 236 Bearing device
238, 240 Bevel gear
242 First transmission device
244, 246, 248 Gear
250 First output element
252 Second axis of rotation
254 Bearing device
256 Second jointed arm portion housing
258, 260 Housing part
262 Edge
264 Sealing device
266 Receiving space
268 Sealing device
270 Third drive element
272, 274 Bearing device
276, 278 Bevel gear
280 Second transmission device
282 Third transmission device
284 Second output element
286, 288 Bearing device
290 Ring
292 Drive gear
294 Output gear
296 Power transmission element
298 Third axis of rotation
300 Toothed belt
302 Tensioning gear
304 Receptacle
306 Feed path
308 Push element
310 Drive unit

1. A handling apparatus for pharmaceutical production material, the handling apparatus comprising:
a supporting device;
a joint device comprising a first jointed arm portion that is rotatable relative to the supporting device;
a tool for handling the pharmaceutical production material, the tool being held directly or indirectly on the first jointed arm portion;
at least one drive device;
a first drive element that is drivable in rotation about a first axis of rotation and connected in a rotationally fixed manner to the first jointed arm portion; and
a second drive element that is drivable in rotation about the first axis of rotation and coupled to a first output element via a first transmission device,
the first output element operatively connected directly or indirectly to the tool for rotating the tool about a second axis of rotation relative to the first jointed arm portion, and
the first jointed arm portion comprising or forming a first jointed arm portion housing in which the first transmission device is accommodated.

2. The handling apparatus according to claim 1,
wherein
the handling apparatus on the joint device and/or on the supporting device is devoid of a drive motor for a jointed arm portion, and/or wherein the handling apparatus on the joint device and/or on the supporting device is devoid of a connecting line for a drive motor on the joint device and on the supporting device.

3. The handling apparatus according to claim 1,
wherein
the first jointed arm portion housing comprises a first housing part and a second housing part as well as a sealing device arranged between the first housing part and the second housing part, wherein the first housing part and the second housing part are sealed relative to one another.

4. The handling apparatus according to claim 1,
wherein
at least one of the following applies:
the first drive element and the second drive element are aligned coaxially with one another and, are adapted to be rotated independently of one another about the first axis of rotation;
the first drive element forms a sleeve or a hollow shaft through which the second drive element is passed, or vice versa.

5. The handling apparatus according to claim 1,
wherein
the supporting device comprises at least one bearing device, wherein the first drive element is rotatably mounted on the supporting device via the at least one bearing device and/or the second drive element is rotatably mounted on the supporting device via the at least one bearing device, and/or wherein the handling apparatus comprises a bearing device via which the first drive element and the second drive element are rotatably mounted on one another.

6. The handling apparatus according to claim 1,
wherein
the supporting device comprises or forms a supporting device housing in which the first drive element and the second drive element are partially arranged, wherein the first drive element and the second drive element are passed through at least one through-opening of the supporting device housing, wherein the first drive element and/or the second drive element is rotationally sealed relative to the supporting device housing by means of a sealing device.

7. The handling apparatus according to claim 6,
wherein
the supporting device housing comprises a first housing part and a second housing part as well as a sealing device arranged, for example, between the first housing part and the second housing part, wherein the supporting device housing is sealed.

8. The handling apparatus according to claim 6,
wherein
the handling apparatus comprises a first coupling element associated with the first drive element and a second coupling element associated with the second drive element, and the first coupling element and the second coupling element are adapted to be driven independently of one another by the at least one drive device, wherein the first coupling element and the second coupling element engage in the supporting device housing and are coupled therein to the respective drive element.

9. The handling apparatus according to claim 8,
wherein
at least one of the following applies:
the first coupling element and the second coupling element are coupled to the first drive element and the second drive element via a toothed connection;
the first coupling element and the second coupling element are aligned coaxially with one another;
the first coupling element is a hollow shaft or forms a hollow shaft through which the second coupling element is passed, or vice versa.

10. The handling apparatus according to claim 6,
wherein
the joint device comprises a second jointed arm portion which is rotatable relative to the first jointed arm portion about the second axis of rotation, wherein the first output element is connected in a rotationally fixed manner to the second jointed arm portion, wherein the tool is pivotably connected to the second jointed arm portion about a third pivot axis, and wherein the handling apparatus comprises a third drive element which is operatively connected to the tool for pivoting about the third pivot axis.

11. The handling apparatus according to claim 10,
wherein
at least one of the following applies:
the third drive element is held on the supporting device and is adapted to be driven in rotation about an axis;
the third drive element is arranged at least partially in the supporting device housing;
the third drive element is aligned coaxially with the first drive element and/or the second drive element;
the third drive element is configured as a drive shaft which is passed through the second drive element and/or first drive element that is configured as a hollow shaft or sleeve.

12. The handling apparatus according to claim 10,
wherein
the supporting device comprises a bearing device via which the third drive element is rotatably mounted about the first axis of rotation, and/or wherein the handling apparatus comprises a bearing device via which the third drive element is rotatably mounted on the second drive element and/or on a first bearing element.

13. The handling apparatus according to claim 10,
wherein
the handling apparatus comprises a first coupling element associated with the first drive element and a second coupling element associated with the second drive element, as well as third coupling element associated with the third drive element and which engages in a supporting device housing of the supporting device and is coupled therein to the third drive element.

14. The handling apparatus according to claim 13,
wherein
at least one of the following applies:
the third coupling element is able to be driven independently of the first coupling element and the second coupling element by means of a drive motor of the at least one drive device;
the third coupling element is coupled to the third drive element via a toothed connection.

15. The handling apparatus according to claim 13,
wherein
at least one of the following applies:
the third coupling element is aligned parallel to the first coupling element and/or the second coupling element;
the third coupling element is aligned coaxially with the first coupling element and/or the second coupling element,
the first coupling element and/or the second coupling element is a hollow shaft or forms a hollow shaft through which the third coupling element is passed, or vice versa.

16. The handling apparatus according to claim 10,
wherein
the handling apparatus comprises a second transmission device coupled to the third drive element, a second output element via which the second transmission device is coupled to a third transmission device arranged on the second jointed arm portion and operatively connected to the tool via a power transmission element.

17. The handling apparatus according to claim 16,
wherein
the second transmission device is arranged in the first jointed arm portion housing, and/or wherein the second transmission device is or comprises a gear transmission.

18. The handling apparatus according to claim 16,
wherein
the second jointed arm portion comprises or forms a second jointed arm portion housing in which the third transmission device is accommodated.

19. The handling apparatus according to claim 16,
wherein
the third transmission device is or comprises a belt drive comprising a drive gear connected in a rotationally fixed manner to the second output element, a drive gear connected in a rotationally fixed manner to the power transmission element, and a belt element running over the drive gear and an output gear.

20. The handling apparatus according to claim 16,
wherein
the first output element is aligned coaxially with the second output element, and/or wherein the first output element forms a sleeve or hollow shaft through which the second output element is guided.

21. The handling apparatus according to claim 16,
wherein
the handling apparatus comprises a bearing device via which the second output element and the first output element are mounted on one another.

22. The handling apparatus according to claim 10,
wherein
the second jointed arm portion has a housing that comprises a first housing part and a second housing part as well as a sealing device arranged between the first housing part and the second housing part, wherein the first housing part and the second housing part are sealed relative to one another.

23. The handling apparatus according to claim 22,
wherein
the housing of the second jointed arm portion is rotationally sealed relative to the first jointed arm portion housing by means of a sealing device.

24. The handling apparatus according to claim 1,
wherein
at least one of the following applies:
the first transmission device is or comprises a gear transmission;
the first jointed arm portion comprises a bearing device by which the first output element is rotatably mounted relative to the first jointed arm portion.

25. The handling apparatus according to claim 1,
wherein
at least one of the following applies:
the tool is configured with multiple positions for simultaneously processing a plurality of copies of the pharmaceutical production material;
the handling apparatus is a feeding apparatus for closing elements for pharmaceutical containers, wherein the tool comprises a receiving body for the closing elements.

26. A handling system for pharmaceutical production material, the handling system comprising:
the handling apparatus according to claim 1; and
a frame that is adapted to be placed on a set-down surface and that comprises a separating element that separates a first zone from a second zone,
wherein:
the first zone being of a higher cleanliness class than the second zone,
the supporting device and the joint device being arranged in the first zone,
the at least one drive device being arranged in the second zone, and
at least one coupling element of the handling apparatus is passed through a through-opening of the separating element.

27. The handling system according to claim 26,
wherein
the handling system comprises a column-shaped carrying device in which the at least one coupling element associated the first drive element or the second drive element is arranged and which extends through or engages in the through-opening or rests against an edge of the through-opening in the first zone, and a sealing device for sealing the through-opening between the first zone and the second zone.

28. The handling system according to claim 27,
wherein
the at least one coupling element or the column-shaped carrying device is devoid of a linear movement through the through-opening.

29. The handling system according to claim 26,
wherein
the handling system comprises at least one transport path for closing elements and a holding element for containers to be closed, wherein the tool is movable from a receiving position to a transfer position, and vice versa, wherein closing elements in the receiving position are received with the tool and in the transfer position are positioned above the container to be closed.

30. The handling system according to claim 29,
wherein
at least one of the following applies:
the tool is movable such that the closing elements have opposite orientations in the receiving position and the transfer position;
the tool is movable such that the closing elements, depending upon design, of the containers to be closed, are received at a same receiving position and assume different transfer positions, which are arranged along a container axis above the containers, wherein containers of different design have identical container axes.

31. A plant for processing pharmaceutical containers, the plant comprising:
the handling system according to claim 26, wherein:
the handling system comprises or forms a closing station for the pharmaceutical containers, and
the plant comprises at least one further processing station for the pharmaceutical containers.
